(19) United States
(12) Patent Application Publication
(10) Pub. No.: US 2014/0319017 A1
(43) Pub. Date: Oct. 30, 2014

(54) MOUNTING APPARATUS FOR STORAGE DEVICES

(71) Applicants: HON HAI PRECISION INDUSTRY CO., LTD., New Taipei (TW); HONG FU JIN PRECISION INDUSTRY (Shenzhen) CO., LTD., Shenzhen (CN)

(72) Inventor: WEN-HU LU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/100,067

(22) Filed: Dec. 9, 2013

(30) Foreign Application Priority Data
Apr. 30, 2013 (CN) 2013101552673

(51) Int. Cl. G06F 1/18

(52) U.S. Cl. CPC G06F 1/187
USPC 206/565

(57) ABSTRACT

A mounting apparatus includes a tray receiving a storage device and a retaining device. The retaining device includes a base member, an arm member, a pressing member, and a sliding member. The base member is secured to the tray. The arm member is attached to the base member and includes a hook. The pressing member is moveably attached to the base member. The sliding member is slidably attached to the base member and abuts the pressing member. The sliding member includes an engaging edge engaged with the hook. The pressing member is moveable in a first direction that is substantially perpendicular to the base member, to move the sliding member in a second direction that is substantially parallel to the base member, so that the engaging edge is disengaged from the hook.

### BACKGROUND

1. Technical Field

The present disclosure relates to mounting apparatuses, and particularly to a mounting apparatus for securing storage devices in an electronic device.

2. Description of Related Art

Many personal computers include data storage devices such as hard disk drives (HDDs), floppy disk drives, and compact disc-read only memory (CD-ROM) drives. In related art, the data storage devices are attached to a chassis of a computer enclosure using screws. When the storage device needs to be maintained or changed, other electronic components near the storage device may inhibit the usage of a screwdriver. It is inconvenient to maintain or change the storage devices. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a mounting apparatus and a storage device in accordance with an embodiment.

FIG. 2 is an exploded, isometric view of a retaining device of the mounting apparatus of FIG. 1.

FIG. 3 is similar to FIG. 1, but viewed from a different aspect.

FIG. 4 is similar to FIG. 2, but viewed from a different aspect.

FIG. 5 is an assembled view of the retaining device of FIG. 4.

FIG. 6 is an assembled view of the mounting apparatus of FIG. 1, and the arm member is located in a close position.

FIG. 7 is cross-sectional view of FIG. 6, taken along a line VII-VII.

FIG. 8 is similar to FIG. 7, and the arm member is disengaged from a sliding member of the mounting apparatus.

FIG. 9 is similar to FIG. 6, and the arm member is located in an open position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

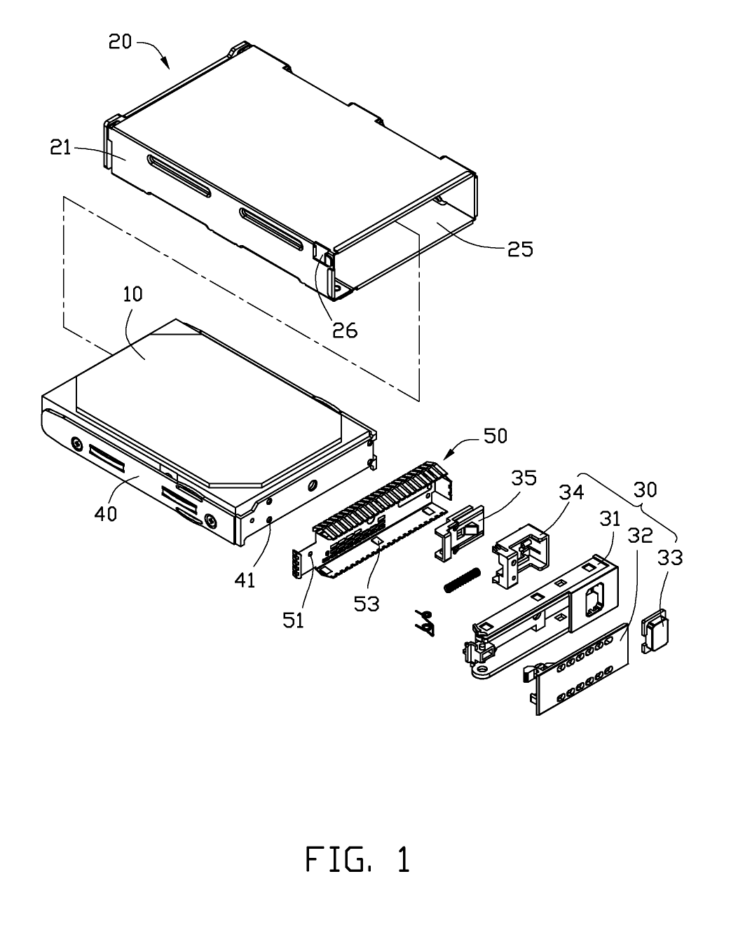

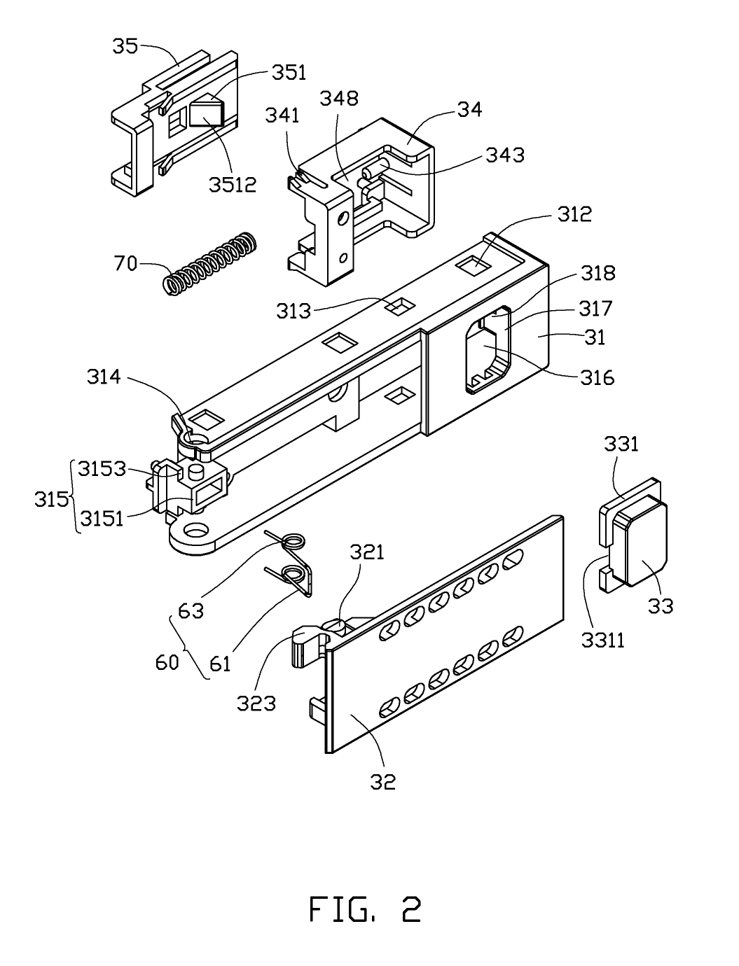

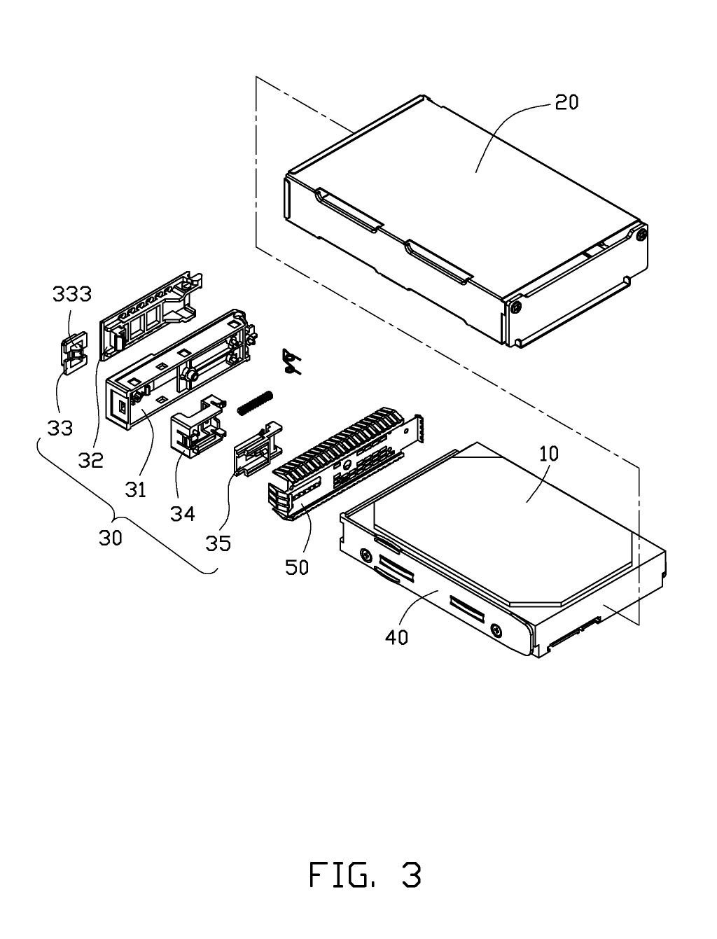

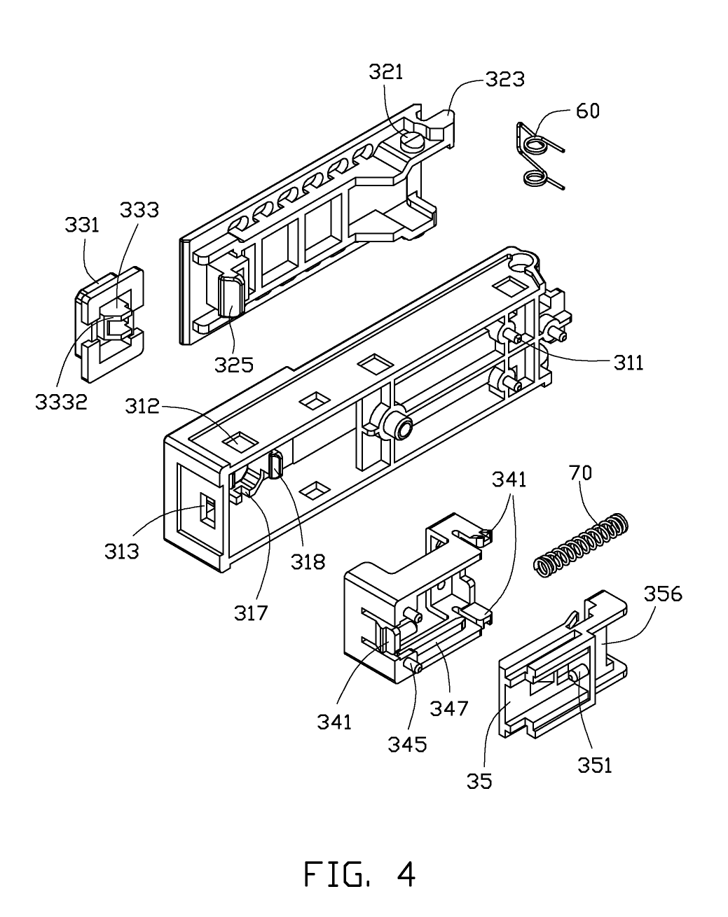

FIGS. 1-4 illustrate a mounting apparatus in accordance with an embodiment. The mounting apparatus comprises a case 20, a tray 40 received in the case 20, and a retaining device 30 secured to the tray 40. The tray 40 is used to secure a data storage device 10. In one embodiment, the storage device 10 is a hard disk drive (HDD), floppy disk drive, and optical disk drive.

The bracket 20 comprises two parallel side plates 21 and a receiving space 25. Each side plate 21 defines a clipping slot 26.

The tray 40 is U-shaped and defines a plurality of securing holes 41. A shielding member 50 can be attached to a front side of the tray 40. A plurality of through holes 51, corresponding to the plurality of securing holes 41, is defined in the shielding member 50. A plurality of protruding pieces 53 protrudes from opposite sides of the shielding member 50. The shielding member 50 is made from flake metal for providing electro-magnetic interference (EMI) shielding.

The retaining device 30 comprises a base member 31, an arm member 32, a pressing member 33, a securing member 34, and a sliding member 35. A plurality of securing posts 311 protrudes from the base member 31. A plurality of receiving holes 312 are defined in opposite sides of the base member 31, and three clamping holes 313 are defined in the base member 31. Two rotating holes 314 are defined in a first end of the base member 31, and a fastening portion 315, located between the two rotating holes 314, protrudes from the first end of the base member 31. The fastening portion 315 comprises a rectangular portion 3151 and two fastening posts 3153 located on opposite sides of the rectangular portion 3151. An opening 316 is defined in a second end of the base member 31. A mounting portion 317 surrounds the opening 316, and two engaging portion 318 connected to the mounting portion 317.

Resilient member 60 can be secured to the fastening portion 315 and comprises a resisting portion 61 and two fixing portion 63 located on opposite sides of the resisting portion 61.

The arm member 32 comprises two rotating posts 321, a clipping portion 323, and a hook 325. The two rotating posts 321 and the clipping portion 323 are located on a first end of the arm member 32, and the hook 325 is located on a second end of the arm member 32.

The pressing member 33 comprises a mounting edge 331 and a pressing block 333 located in the mounting edge 331. The mounting edge 331 defines two cutouts 3311 corresponding to the two engaging portions 318. The pressing block 333 comprises a slanted pressing edge 3332.

The securing member 34 can be secured to the base member 31 and comprises three clamping portions 341, a first fixing post 343, and two securing posts 345. The three clamping portions 341 correspond to the three clamping holes 313. The securing member 34 further defines an extending hole 346, two sliding slots 347, and an extending hole 348.

The sliding member 35 can be slidably engaged in the two sliding slots 347 and comprises an engaging block 351, a second fixing post 353, and an engaging edge 356. The engaging block 351 is located on a first side of the sliding member 35 and comprises a slanted engaging edge 3512. The second fixing post 353 is located on a second side of the sliding member 35. A spring 70 can be secured to the first fixing post 343 and the second fixing post 353.

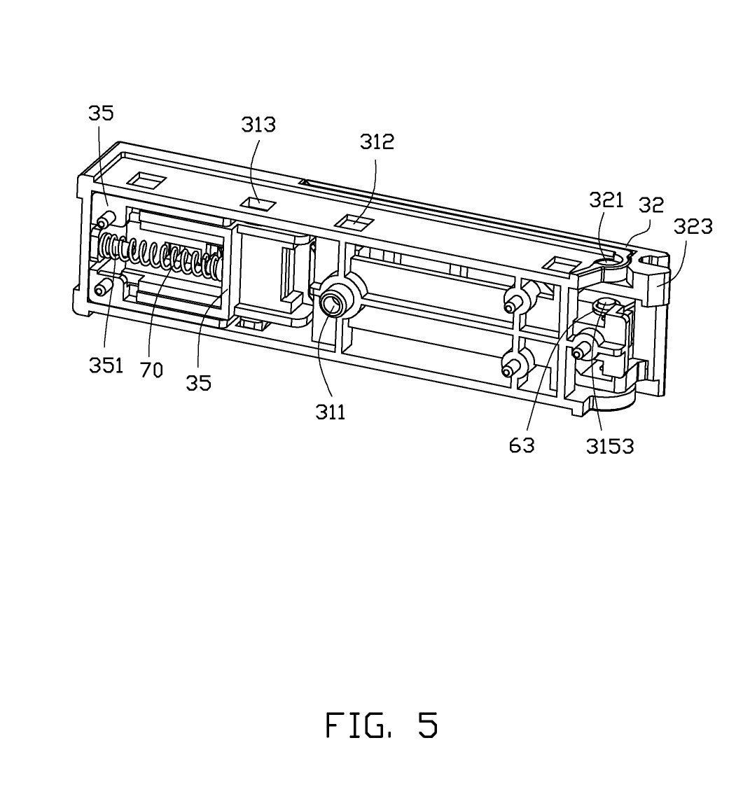

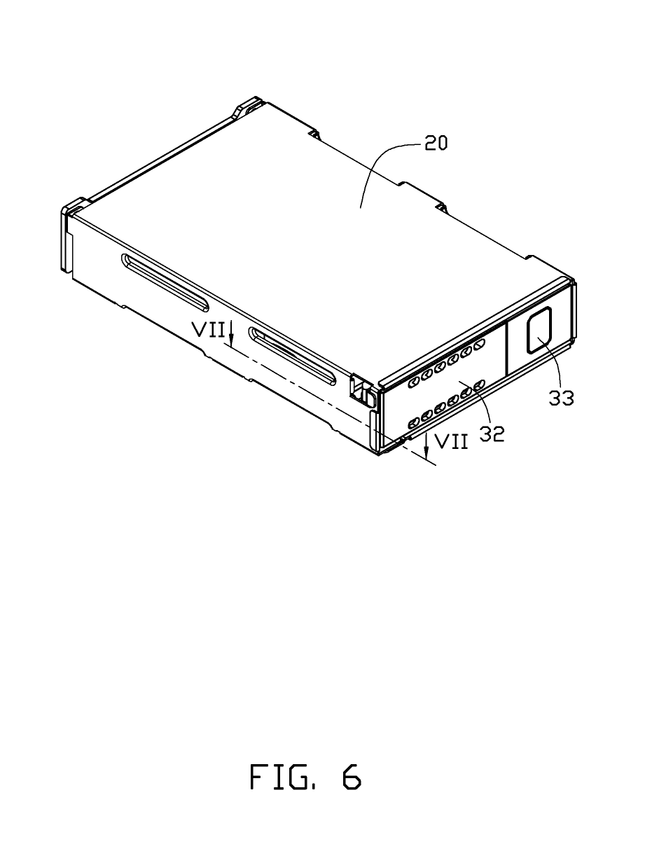

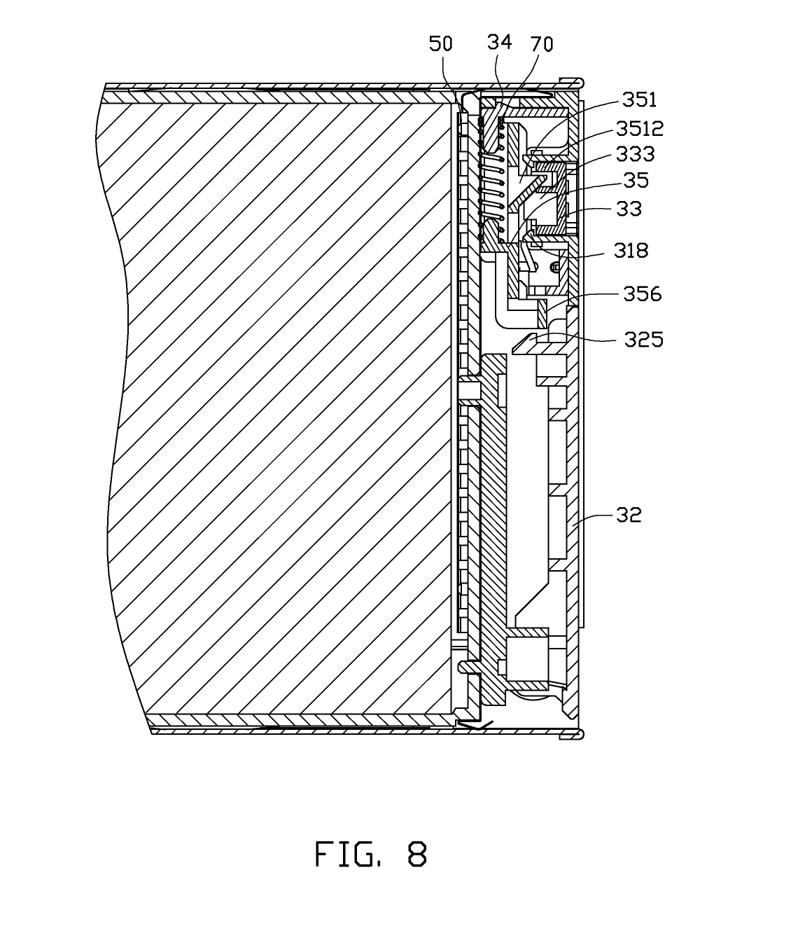

FIGS. 5-9 illustrate in assembly, the pressing member 33 is located on an inner side of the base member 31 and extends through the opening 316, until the pressing member 33 is located on an outer side of the base member 31. At this time, the mounting edge 331 is engaged with the mounting portion 317. Thus, the pressing member 33 is secured to the base member 31.

The sliding member 35 is located on the securing member 34, and opposite edges of the sliding member 35 are slidably received in the two sliding slots 347. Thus, the sliding member 35 is slidably engaged with the sliding member 35. At this time, the engaging block 351 extends through the extending hole 348. A first end of the spring 70 is engaged with the first fixing post 343, and a second end of the spring 70 is engaged with the second fixing post 353. Thus, the spring 70 is secured to the sliding member 35 and the securing member 34.

The securing member 34 is located on the base member 31. The three clamping portions 341 are clamped into the corresponding clamping holes 313, to secure the securing member 34 to the base member 31. At the time, the slanted pressing edge 3332 abuts the slated engaging edge 3512.

The resisting portion 61 is engaged with the rectangular portion 3151, and the fixing portions 63 are engaged with the two fastening posts 3153, to secure the resilient member 60 to the fastening portion 315. The rotating posts 321 are received in the corresponding rotating holes 314, to rotatably secure the arm member 321 to the base member 31. At this time, the resisting portion 61 resists an inner surface of the arm member 32.

The shielding member 50 is located on the front side of the tray 40, and the plurality of through holes 51 are aligned with the plurality of securing holes 41. The securing posts 311 of the base member 31 and the securing posts 345 of the securing member 34 extend through the plurality of through holes 51 and engaged in the plurality of securing holes 41, to secure the retaining device 30 to the tray 40.

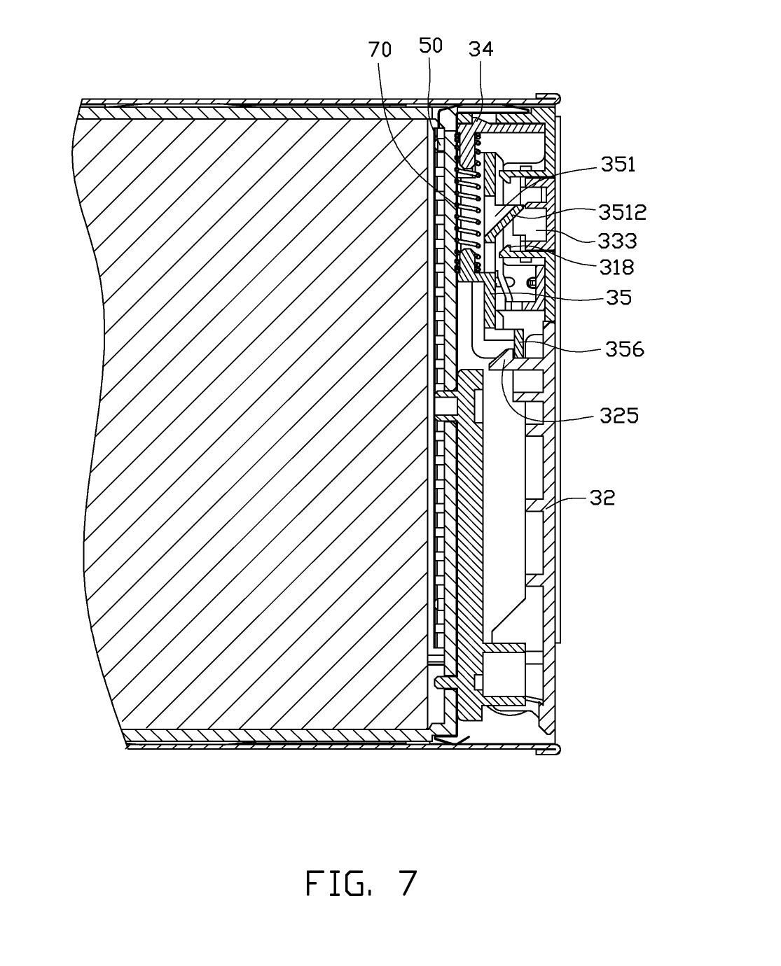

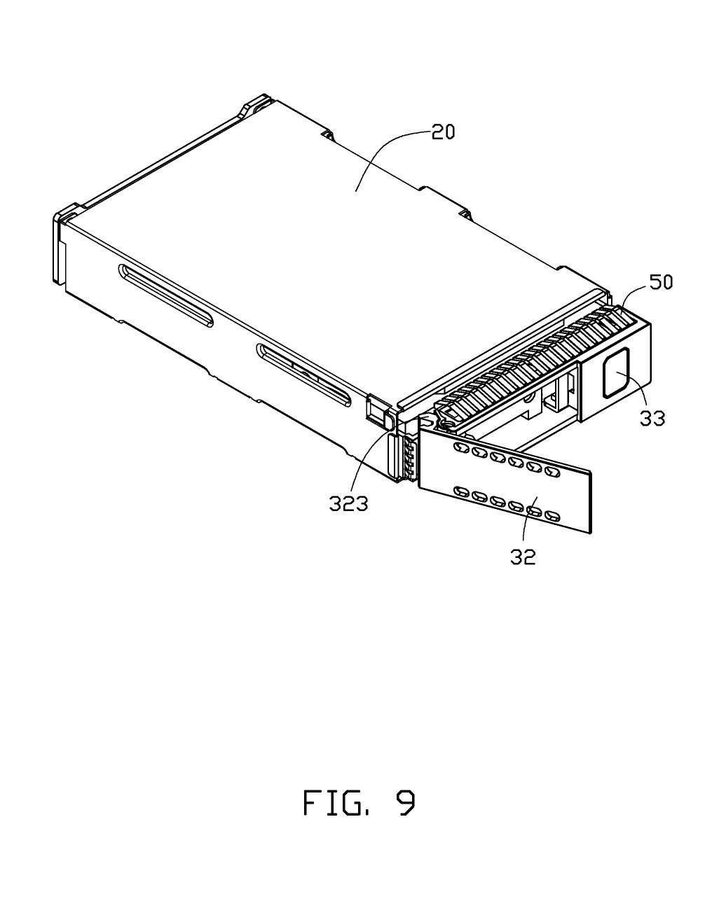

The arm member 32 is rotatable relative to the base member 31 in an open position (see FIG. 9) and a close position (see FIG. 7). In the closed position, the hook 325 is engaged with the engaging edge 356, and the resilient member 60 is deformed. In the open position, the hook 325 is disengaged from the engaging edge 356.

To secure the tray 40 in the bracket 20, the tray 40 is located in the receiving space 25. At this time, the arm member 32 is located in the open position. The arm member 32 is pressed towards the base member 31, until the clipping portion 323 is aligned with the clipping hole 26. The arm member 32 is further pressed, until the clipping portion 323 is clipped in the clipping hole 26, and the hook 325 is engaged with the engaging edge 356. The resilient member 60 is compressed. The retaining device 30 is then mounted to the bracket 20.

When removing the retaining device 30 from the bracket 20, the pressing member 33 is pressed in a first direction that is substantially perpendicular to the base member 31 and towards the base member 31, until the engaging portions 318 are engaged in the two cutouts 3311. The slanted pressing edge 3332 urges the slanted engaging edge 3512, so that the sliding member 35 is slid relative to the securing member 34 in a second direction that is substantially parallel to the base member 31 and away from the hook 325. Simultaneously, the spring 70 is deformed. When the hook 325 is disengaged from the engaging edge 356, the resilient member 60 is released to rotate the arm member 32 away from the base member 3, to disengage the clipping portion 323 from the clipping hole 26. Then, the spring 70 is released to pull back the sliding member 35. Thus, the retaining device 30, with the tray 40, can be moved out of the bracket 20.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus comprising:
a tray configured to receive a storage; and
a retaining device attached to the tray and comprising:
a base member secured to the tray;
an arm member rotatably attached to the base member and comprising a hook;
a pressing member moveably attached to the base member; and
a sliding member slidably attached to the base member and abutting the pressing member; the sliding member comprising an engaging edge engaged with the hook;
wherein the pressing member is moveable in a first direction that is substantially perpendicular to the base member, to move the sliding member in a second direction that is substantially parallel to the base member, so that the engaging edge is disengaged from the hook.

2. The mounting apparatus of claim 1, wherein the retaining device further comprises a spring located between the sliding member and the base member; when the sliding member is moved in the second direction, the spring is deformed.

3. The mounting apparatus of claim 2, wherein the retaining device further comprises a securing member secured to the base member, the securing member defines two sliding slots, and opposite sides of the sliding member is slidably received in the two sliding slots.

4. The mounting apparatus of claim 1, wherein the pressing member comprises a pressing block extending through the base member, the pressing block comprises a slanted pressing edge; and the sliding member comprises an engaging block, and the engaging block comprises a slanted engaging edge abutting the slanted pressing edge.

5. The mounting apparatus of claim 4, wherein the base member comprises an opening for the pressing block extending through; a mounting portion surrounds the opening, and the pressing member comprises a mounting edge engaged with the mounting portion.

6. The mounting apparatus of claim 5, wherein two cutouts are defined in the mounting edge, two engaging portions are located on the mounting portion; and when the pressing member is moved in the first direction, the two engaging portions are engaged with the two cutouts.

7. The mounting apparatus of claim 1, further comprising a bracket configured for receiving the tray; wherein the bracket defines a clipping hole, and the arm member comprises a clipping portion engaged in the clipping hole.

8. The mounting apparatus of claim 1, wherein the base member defines two rotating holes, and the arm member comprises two rotating posts rotatably engaged in the two rotating holes.

9. The mounting apparatus of claim 8, wherein the retaining device further comprises a resilient member, the resilient member comprises a resisting portion and two fixing portions; a fastening portion is located between the two rotating holes and comprises a rectangular portion and two fastening posts located on opposite sides of the rectangular portion; the resisting portion is engage with the rectangular portion, and the two fixing portion are engaged with the two fastening posts.

10. The mounting apparatus of claim 1, further comprising a shielding member, wherein the base member defines a plurality of receiving holes, and the shielding member comprises a plurality of protruding pieces engaged in the plurality of receiving holes.

11. A mounting apparatus comprising:
a bracket defining a clipping hole;
a tray configured to receive a storage and received in the bracket; and
a retaining device comprising:
a base member secured to the tray;
an arm member rotatably attached to the base member and comprising a hook and a clipping portion; a resilient member secured to the base member and resisting the arm member;
a pressing member moveably attached to the base member; and
a sliding member slidably attached to the base member and abutting the pressing member; the sliding member comprising an engaging edge;
wherein the arm member is rotatable relative to the base member between a close position and an open position by the pressing member; in the close position, the engaging edge is engaged with the hook, the clipping portion is engaged in the clipping hole, and the resilient member is deformed; in the open position, the engaging edge is disengaged from the hook, and the clipping portion is removed from the clipping hole.

12. The mounting apparatus of claim 11, wherein the retaining device further comprises a spring located between the sliding member and the base member; when the sliding member is deformable in a direction that is substantially parallel to the base member.

13. The mounting apparatus of claim 12, wherein the retaining device further comprises a securing member secured to the base member, the securing member defines two sliding slots, and opposite sides of the sliding member is slidably received in the two sliding slots.

14. The mounting apparatus of claim 11, wherein the pressing member comprises a pressing block extending through the base member, the pressing block comprises a slanted pressing edge; and the sliding member comprises an engaging block, and the engaging block comprises a slanted engaging edge abutting the slanted pressing edge.

15. The mounting apparatus of claim 14, wherein the basing member comprises an opening for the pressing block extending through; a mounting portion surrounds the opening, and the pressing member comprises a mounting edge engaged with the mounting portion.

16. The mounting apparatus of claim 15, wherein two cutouts are defined in the mounting edge, two engaging portions are located on the mounting portion; and when the pressing member is moved in the first direction, the two engaging portions are engaged with the two cutouts.

17. The mounting apparatus of claim 11, wherein the base member defines two rotating holes, and the arm member comprises two rotating posts rotatably engaged in the two rotating holes.

18. The mounting apparatus of claim 17, wherein the resilient member comprises a resisting portion and two fixing portions; a fastening portion is located between the two rotating holes and comprises a rectangular portion and two fastening posts located on opposite sides of the rectangular portion; the resisting portion is engage with the rectangular portion, and the two fixing portion are engaged with the two fastening posts.

19. The mounting apparatus of claim 11, further comprising a shielding member, wherein the base member defines a plurality of receiving holes, and the shielding member comprises a plurality of protruding pieces engaged in the plurality of receiving holes.
